(19) United States
(12) Patent Application Publication
(10) Pub. No.: US 2019/0183711 A1
(43) Pub. Date: Jun. 20, 2019

(54) STORABLE REHABILITATION TABLE AND DESK

(71) Applicant: Cardon Rehabilitation & Medical Equipment Ltd., Burlington (CA)

(72) Inventors: Mardig Sevadjian, Oakville (CA); Chester Lake, Ajax (CA)

(21) Appl. No.: 15/847,715

(22) Filed: Dec. 19, 2017

(51) Int. Cl. A61G 13/10; A47B 21/02; A47C 17/62; A61G 13/00; A61G 13/06

(52) U.S. Cl. CPC A61G 13/105; A47B 21/02; A47B 3/12; A61G 13/009; A61G 13/06; A47C 17/62

(57) ABSTRACT

A storable dual-use table having a reversible desktop with a desk on one side and a pad on the other side to convert from a rehabilitation table to a desk by flipping the desktop over. The desktop can be stored apart from the support structure of desktop frame and legs. The table has height adjustable legs to provide different heights depending on whether the table is being used as a table or as a desk. A leg storing system allows the legs to be folded parallel to the desktop frame in order for the support structure to be compact for storage.

### FIELD OF THE INVENTION

The present invention relates to a storable dual-use table and more particularly to a storable rehabilitation table and desk comprising a reversible desktop, height adjustable legs and a leg storing system.

### BACKGROUND OF THE INVENTION

Rehabilitation or treatment tables typically provide unobstructed surfaces for patients or clients to lie on to enable a therapist to provide treatment to a patient or client, and for the therapist to move around the bed as required. Rehabilitation tables need to accommodate individuals of different sizes that require a variety of treatments for various parts of the body, and they need to enable the therapists treating the individuals to be able to reach the various parts of the body to be treated. Therapists, in this context, refer to anyone who needs to access a patient or client on a treatment table (whether for actual treatment or training purposes), and treatment refers to any contact with an individual with or without devices or other aids.

Rehabilitation tables have been adapted to comprise sections, such as a head section, fixed or adjustable center section and leg section, in order to adjust the table for the individual being treated as well as improve the accessibility to the patient or client for the therapist. Other treatment tables have only one or two sections rather than three, or additionally include side sections capable of being used as arm rests and of being raised or lowered.

There are several types of adjustable treatment tables, for example, as described in U.S. Pat. Nos. 8,672,971 and 7,189,214. In U.S. Pat. No. 8,374,312 there is described a treatment table with two sections and with modifications specifically to allow a radiation beam to pass through a body portion exposed by an opening in the table.

There are instances in which tables are required for seated activities, such as for taking notes; however, these tables are also utilized for standing activities, such as manual physical therapy. Tables fixed at a height for seated activities are not necessarily at the right height for standing activities due to the different heights of therapists and size of patients, and this causes challenges and discomfort for therapists especially when standing at a table of the wrong height. Tables for therapy are often cushioned since patients lie on them; however, this is not helpful for writing on the table since a hard surface, such as a binder or text book, is required to enable proper writing.

There are several methods for adjusting the height of tables, for example, as described in Canadian Patent Nos. 2,199,316 (Adjustable Height Tables) and 2,394,678 (Height Adjustable Table), and Canadian patent application nos. 2,609,895 (Height Adjustable Table) and 2,649,053 (Multi Adjustable Table Attachment). These tables have specific combinations of height and bed type, but no adaptation for use of the table for writing.

Some classrooms and rooms are used for a variety of purposes and need: tables to accommodate treatment activities for training therapies; tables for use for seated therapy; desks for writing activities; and storable tables and desks for activities which require space.

### SUMMARY OF THE INVENTION

In an embodiment of the present invention, there is a rehabilitation table and desk comprising a reversible two sided desktop having a pad on one of the two sides of the desktop, a four sided desktop frame having at least one desktop stop on each side on which the desktop rests, and four legs.

In a further embodiment of the present invention, the rehabilitation table and desk additionally comprises a leg storing system for storing each of the legs, and the legs may be height adjustable legs.

In an embodiment of the present invention there is a leg storing system for a desk or table, comprising an outer bar forming a sleeve over an inner bar and slidable bar, the inner bar comprising a first portion ending in a first end which is attachable to a leg and a second portion ending in a second end with a stop, the slidable block attached to the outer bar and slidable only along the second portion up to the stop, the outer bar securable to the first portion of the inner bar by a removable hitch pin in either a first position or a second position which is about a ninety degree turn from the first position. When the hitch pin is removed, the outer bar may be pulled away from the first end of the inner bar until the slidable block abuts the stop and the inner bar may be turned, unless the hitch pin is secured.

In a further embodiment of the invention, the leg storing system is secured to a table or desk and the first end of the inner bar is attached to a leg of the table or desk, and in the first position the leg is in position to support the table or desk and in second position the leg is in stored position.

### BRIEF DESCRIPTION OF THE FIGURES

These and other aspects of the present invention will be apparent from the brief description of the drawings and the following detailed description in which:

FIG. 1 is a perspective view of a rehabilitation table and desk of an embodiment of the present invention in desk mode.

FIG. 2 is a perspective view of an embodiment of a rehabilitation table and desk in table mode with table extension and head rest.

FIG. 3 is an exploded perspective view of the rehabilitation table and desk of FIG. 2 in storage mode.

FIG. 4 is a right side view of the rehabilitation table and desk of FIG. 1.

FIG. 5 is an exploded view of a leg storing system of an embodiment of the present invention.

FIG. 6 is a perspective view of part of the leg storing system of FIG. 5 in locked mode.

FIG. 7 is a perspective view of part of a leg storing system of FIG. 5 in storing mode.

FIG. 8 is a cross-section view of the leg storing system of FIG. 6.

FIG. 9 is a cross-section view of the leg storing system of FIG. 7.

FIG. 10 is a perspective view of an embodiment of an adjustable leg of a rehabilitation table and desk in hold mode.

FIG. 11 is a perspective view of the adjustable leg of FIG. 10 in adjusting mode.

### DETAILED DESCRIPTION OF THE INVENTION

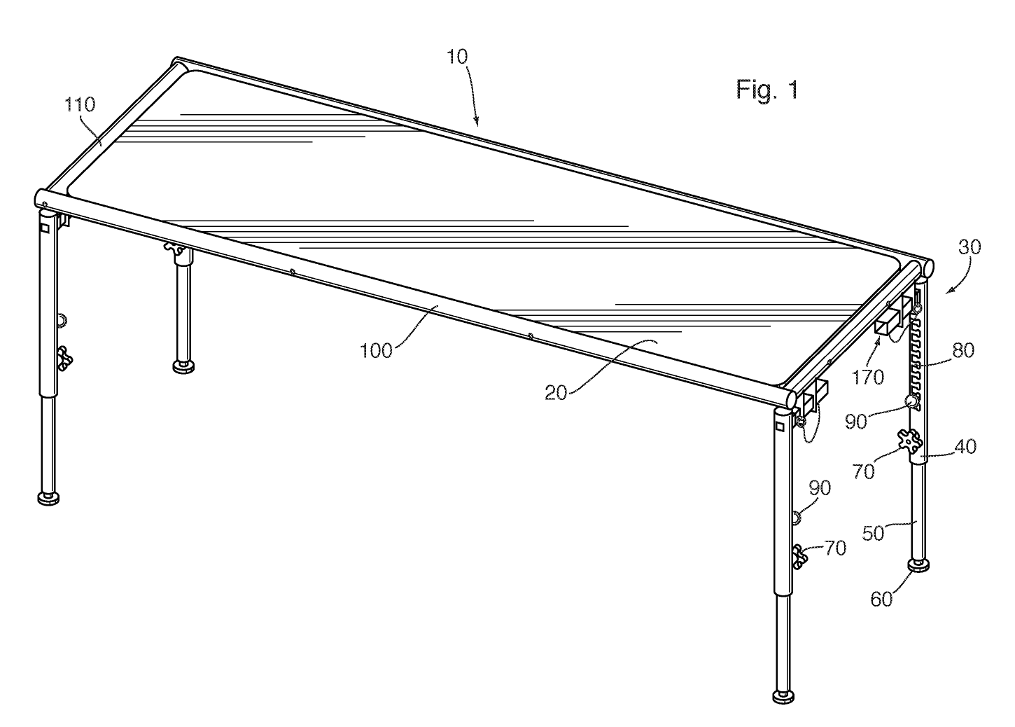

FIG. 1 shows an embodiment of a rehabilitation table and desk 10 of the present invention in desk mode with a desktop 20 within a desktop frame of side railings 100 and end railings 110, with four adjustable legs 30 and a leg storing system 170 for each leg 30.

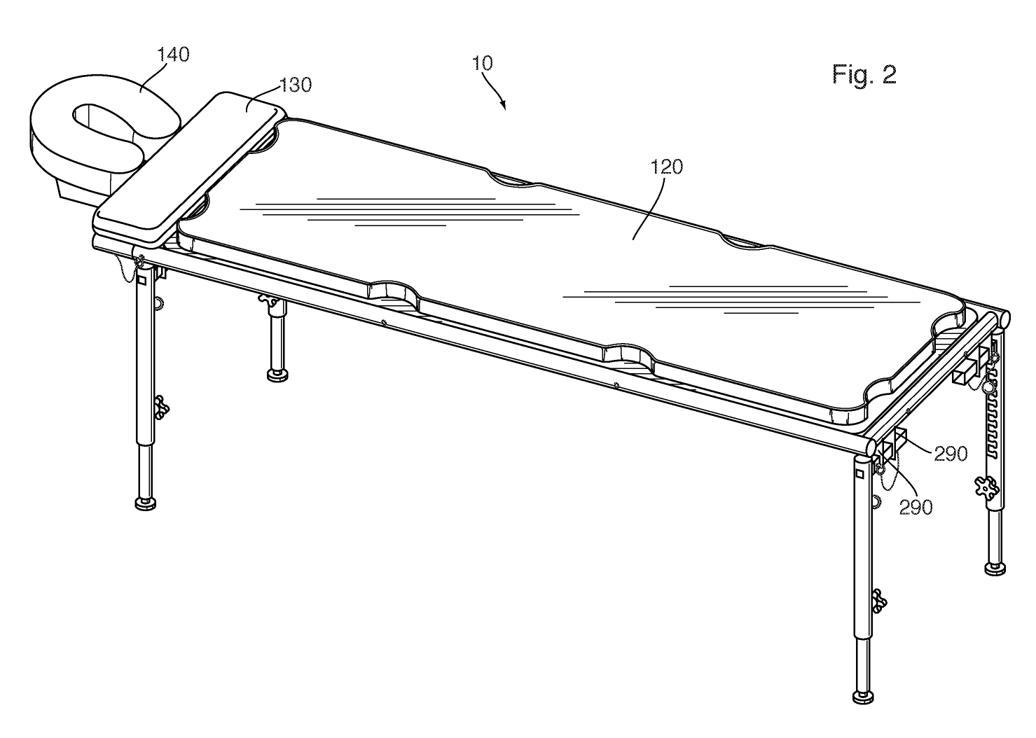

FIG. 2 shows an embodiment of a rehabilitation table and desk 10 of the present invention in rehabilitation table mode in which the desktop 20 additionally comprises a pad 120 on one side of the reversible desktop. In this embodiment there is a table extension 130 and a head rest 140 which are removable and storable apart from the table. A table extension 130 can be sized to make the table long enough for a patient to comfortably lie on the table, for example, four inches, to further adapt the desk into a table for any particular therapy or height of patient, and the table extension 130 can be used with or without a head rest 140. Likewise the head rest 140 could be used without a table extension 130.

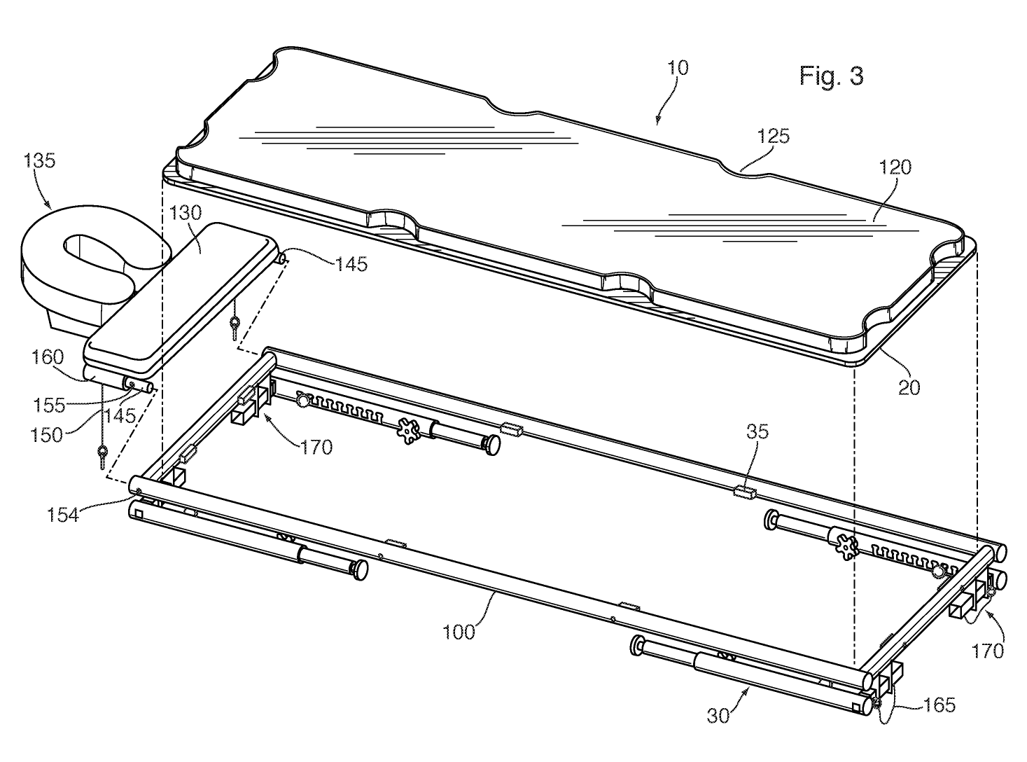

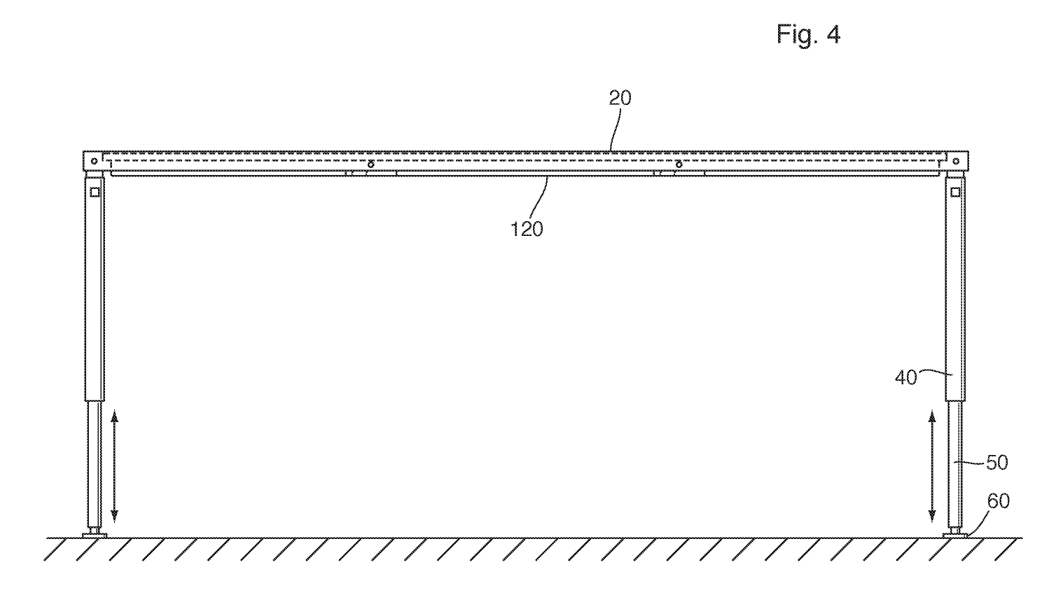

As seen in FIGS. 3 and 4, the desktop 20 with pad 120 is in table mode in FIG. 3 and can be flipped over to adapt to a desk mode in FIG. 4 since the reverse side is only the desktop 20. As shown in FIG. 3, desktop stops 35 on each of the side railings 100 and end railings 110 allow the desktop 20 to rest within the desktop frame on the desktop stops 35. In this embodiment there are two desktop stops 35 shown on each of the sides and ends, which may be varied provided that the desktop 20 is supported adequately. The support structure is collectively the desktop frame (side railings 100 and end railings 110), desktop stops 35, legs 30, and leg storing system 170. FIG. 3 is an exploded view of the rehabilitation table and desk 10 of FIG. 2 in storage mode since each of the components of desktop 20, head rest 140, table extension 130, and support structure can be stored separately.

The rehabilitation table and desk 10 is reversed from the desk mode shown in FIG. 4 to table mode by reaching under the desktop 20 to push the pad 120 off of the desktop stops 35 and flip it over so that the pad 120 is facing up and the desktop 20 is resting on the desktop stops 35 again. For stability, in this embodiment the pad 120 has cut-outs 125 so that the desktop 20, rather than the pad 120, rests on the desktop stops 35.

In an embodiment of the invention shown in FIG. 3, the head section unit 135 comprises the head rest 140 and table extension 130. The table extension 130 is of about the same width as the table and has unit side rails 160 with joining pipes 145. The joining pipes 145 fit snugly into the hollow interior of the side rails 100 such that the ends of the unit side rails 160 abut the ends of the side rails 100. The head section unit 135 may be secured to the table by head hitch pins 150 through aligned rail hole 154 and joining hole 155. The head section unit 135 could be attached in alternate manners, preferably removable and separately storable.

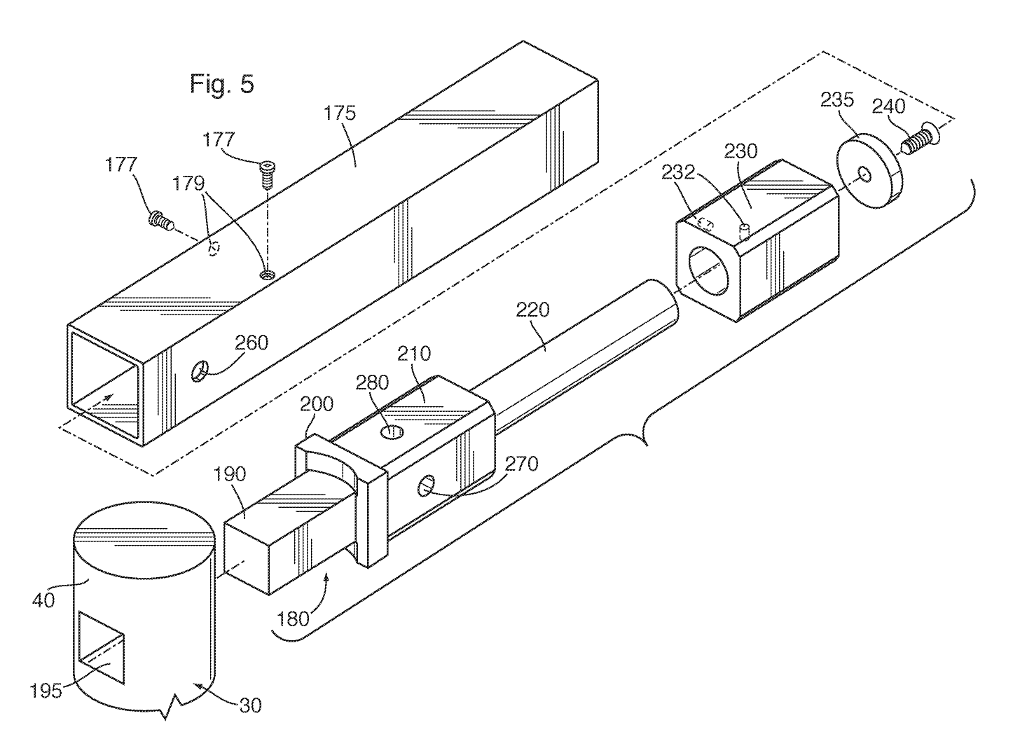

As shown in FIG. 3, in order to store the components of the rehabilitation table and desk 10, the desktop 20 is lifted off of the support structure; the head section unit 135 is detached by removing the hitch pins 150 and pulling the joining pipes 145 out of the side rails 100; and the structure support is collapsed using the leg storing system 170. In order to collapse the structure support, the rehabilitation table and desk 10 may be placed on its side, leg hitch pins 165 are removed and as shown in FIGS. 5 through 9 and described below, the leg storing system 170 functions to allow the legs 30 to be folded in. The leg storing system 170 may additionally include compressor knobs (not shown) for additional stability, similar to the compressor knobs 70 of the legs 30.

FIGS. 5 to 9 show an embodiment of the leg storing system 170 of the present invention. The leg storing system comprises an outer bar 175, an inner bar 180, slidable block 230 and stop 235. The inner bar 180 comprises a leg plug 190, flange 200, fixed block 210 and pipe 220. The inner bar 180 is attached to the upper leg 40 through wedging the leg plug 190 into a square hole 195 on the upper leg 40, up to a flange 200. The slidable block 230 has a hollow interior to enable it to slide along pipe 220 and is prevented from coming off the pipe 220 by stop 235 attached to pipe 220, in this example by stop 235 being bolted on to the end of pipe 220 by a bolt 240. The slidable block 230 is attached to the outer bar 175, in this example by outer bar screws 177 through screw holes 179 which thread into slidable bar holes 232.

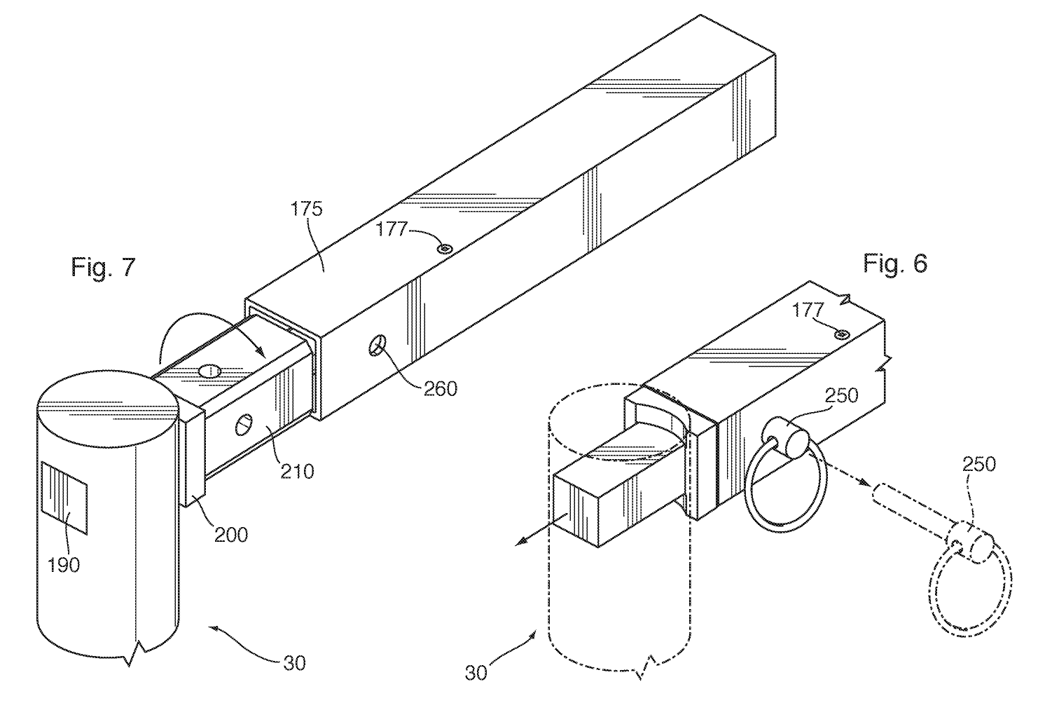

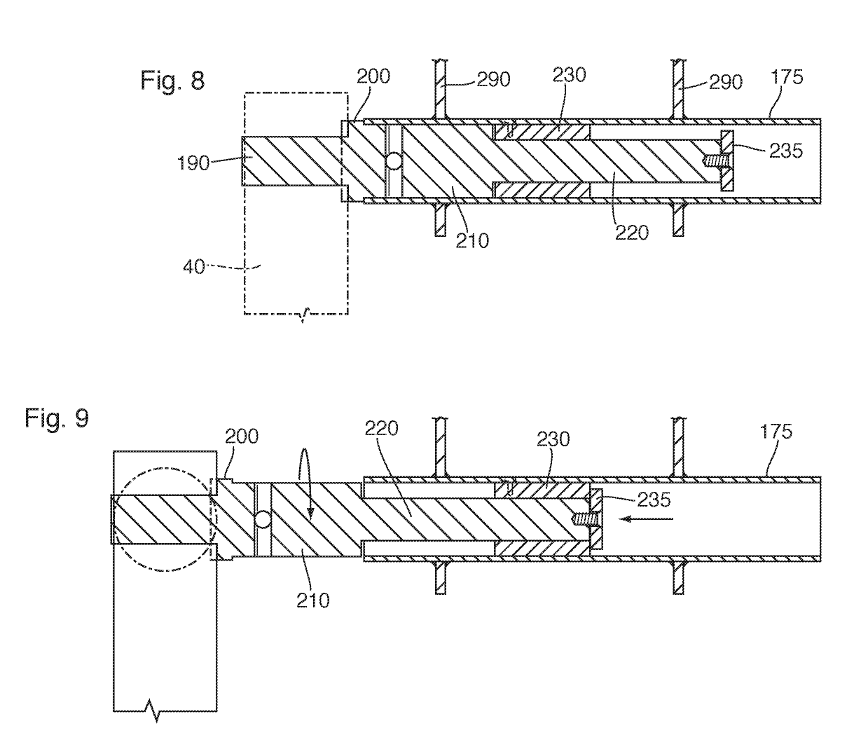

FIGS. 6 and 8 show the leg storing system 170 with the leg 30 in position when in use for supporting the desktop 20 of a table and desk. A bars hitch pin 250 retains the outer bar 175 to the inner bar 180 through outer bar hole 260 and first inner bar hole 270, as shown in FIG. 5. By removing hitch pin 250, the leg 30 is pulled away so that the outer bar 175 passes over fixed block 210, as shown in FIGS. 7 and 9 to enable a 90 degree turn of leg 30, which moves the leg 30 to storable mode parallel with the side rail 100, and the leg is pushed in and bars hitch pin 250 is then inserted into an aligned outer bar hole 260 and a second inner bar hole 280, to maintain the leg 30 in storable mode. Two leg storing systems 170 are attached to each end railing 110 and in the embodiment shown in the figures this is through a pair of joining bars 290 on each leg storing system 170.

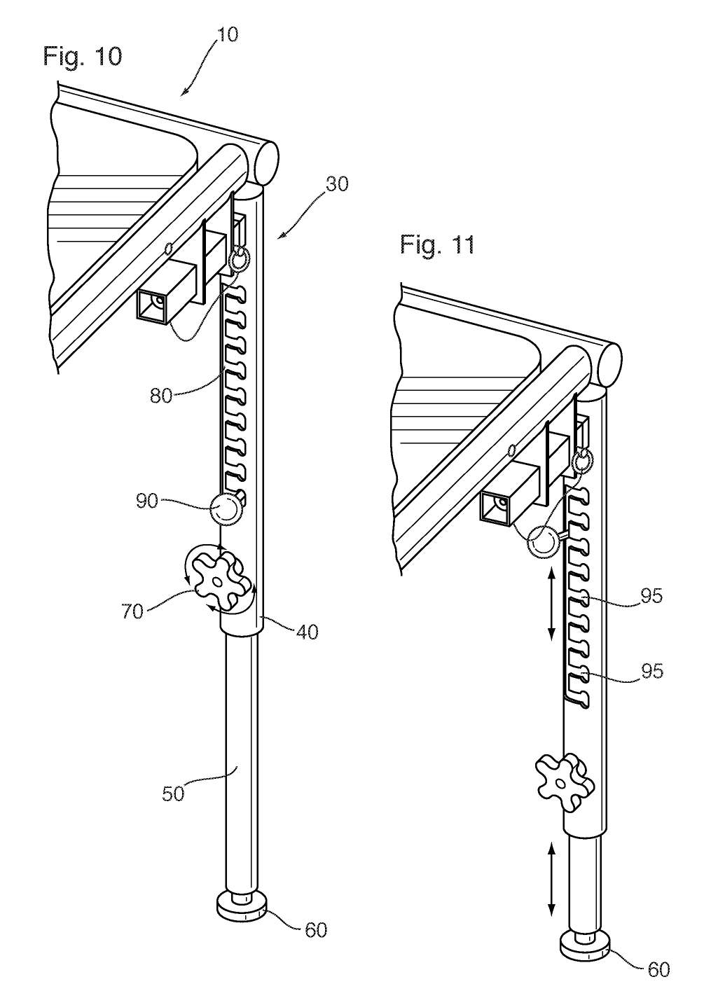

FIGS. 10 and 11 show how an adjustable leg 30 of a rehabilitation table and desk 10 of an embodiment of the present invention can be raised and lowered so that it is adaptable for a preferred desk or table height. For example, a higher desk than a table may be desired if the table needs to be low enough for someone to comfortably get onto it. In order to lower the rehabilitation table and desk 10, shown in hold mode in FIG. 10, an optional leg compressor knob 70 on upper leg 40 is loosened and then a channel knob 90 is moved from a resting slot 95 into and upwards along a channel 80 as shown in FIG. 11, in adjusting mode. When the channel knob 90 is in a higher slot, the rehabilitation table and desk 10 is at a lower height, and then the leg compressor knob 70 is tightened to prevent movement of the legs. In this embodiment the leg 30 is stabilized at the end of the lower leg 50 by an optional foot 60, which alternatively could be a wheel with a stop brake (not shown).

In FIG. 11 after a higher resting slot 95 is chosen, the desktop 20 is lower than in FIG. 10. In order to raise the rehabilitation table and desk 10, the leg compressor knobs 70 are loosened and rehabilitation table and desk 10 is tilted to one side and the legs 30 on that side are raised from the floor and on each the channel knob 90 is moved from a resting slot 95 into the channel 80 and down to a lower resting slot 95 and then the legs 30 on that side are lowered down and the rehabilitation table and desk 10 is tilted to the other side to adjust the legs 30 on the other side.

The desktop 20 of the rehabilitation table and desk 10 of the present invention may be comprised of any material suitable to writing on and strong enough for a patient to lie or sit on, for example, a carbon fibre desktop 20. The pad 120 is a pad suitable for a rehabilitation table. The legs and railings are steel tubing, but may be aluminum, and the leg storing system is steel but may be aluminum or bronze, and these parts may be combinations of these metals or other suitable materials provided that they are of sufficient strength and durability.

The leg storing system may be used with any table or desk whether or not comprising a reversible top, and may be used to build tables and desks with storable legs or to convert existing tables and desks provided that the leg storing system is capable of securely attaching to the desktop and legs to be used.

While embodiments of the invention have been described in the detailed description, the scope of the claims should not be limited by the preferred embodiments set forth in the examples, but should be given the broadest interpretation consistent with the description as a whole.

What is claimed is:

1. A rehabilitation table and desk comprising a reversible two sided desktop having a pad on one of the two sides of the desktop, a four sided desktop frame having at least one desktop stop on each side on which the desktop rests, and four legs.

2. The rehabilitation table and desk of claim 1, which additionally comprises a leg storing system for each leg, each of said leg securing systems being secured to the desktop frame and the leg.

3. The rehabilitation table and desk of claim 2, in which the legs are height adjustable.

4. The rehabilitation table and desk of claim 2, in which each leg storing system comprises an outer bar secured to the desktop frame, said outer bar forming a sleeve over an inner bar and slidable bar, said inner bar comprising a first portion ending in a first end which is attached to a leg and a second portion ending in a second end with a stop, said slidable block is attached to said outer bar and slidable along said second portion up to the stop, said outer bar is securable to the first portion of the inner bar by a removable hitch pin in either a first position to support the table or desk or a second position which is about a ninety degree turn from the first position to store the leg, wherein when the hitch pin is removed said leg may be pulled away until the slidable block abuts the stop and the inner bar may be turned.

5. The rehabilitation table and desk of claim 4, in which the legs are height adjustable.

6. A leg storing system for a desk or table, comprising an outer bar forming a sleeve over an inner bar and slidable bar, said inner bar comprising a first portion ending in a first end which is attachable to a leg and a second portion ending in a second end with a stop, said slidable block is attached to said outer bar and slidable along said second portion up to the stop, said outer bar securable to the first portion of the inner bar by a removable hitch pin in either a first position or a second position which is about a ninety degree turn from the first position, wherein when the hitch pin is removed said first end of the inner bar may be pulled away from the outer bar until the slidable block abuts the stop and the inner bar may be turned.

7. The leg storing system of claim 6, in which the leg storing system is secured to a table or desk and the first end of the inner bar is attached to a leg of the table or desk, and in the first position the leg is in position to support the table or desk and in second position the leg is in stored position.
